(19) United States
(12) Patent Application Publication
(10) Pub. No.: US 2025/0224287 A1
(43) Pub. Date: Jul. 10, 2025

(54) FIBER BRAGG GRATING FOR MEASURING INTERNAL METAL LOSS

(71) Applicants: Saudi Arabian Oil Company, Dhahran (SA); King Abdullah University of Science and Technology, Thuwal (SA)

(72) Inventors: Abderrahim Fakiri, Dhahran (SA); Shaj K. Manjalivalapil, Abqaiq (SA); Md Anwar Parvez, Dhahran (SA); Alaaeddine Rjeb, Thuwal (SA); Islam Ashry, Thuwal (SA); Boon Siew Ooi, Thuwal (SA)

(21) Appl. No.: 18/406,845

(22) Filed: Jan. 8, 2024

(51) Int. Cl. G01L 1/24; F16L 58/10; F16L 101/30; G01B 11/16

(52) U.S. Cl. CPC G01L 1/246; F16L 58/1063; G01B 11/165; F16L 2101/30

(57) ABSTRACT

A system and methods for monitoring internal corrosion in a compromised pipe are provided. An exemplary includes applying a reinforcement layer on an outer surface of a pipe over a defect detected in an internal surface of the pipe. A testing fiber Bragg grating (FBG) detector is mounted on the outer surface of the pipe over the defect. A reference FBG detector is mounted on the outer surface of the pipe. A difference in hoop strain between the testing FBG detector and the reference FBG detector is monitored to identify variations in wall thickness over the defect.

### TECHNICAL FIELD

This disclosure relates to methods of using fiber Bragg grating (FBG) sensors to quantify metal loss occurring on and internal surface in a repaired pipe section having an overlying reinforcement layer.

### BACKGROUND

Pipelines are an essential part of the oil and gas industry, as they provide a safe and efficient way to transport oil and gas over long distances. Pipelines help to maintain the stability of energy supplies, support economic growth, and ensure the smooth functioning of modern societies. Thus, pipeline integrity is critical for ensuring the safe and reliable transportation and distribution of oil and gas while preventing leaks, ruptures, and potential failures.

Metallic pipes suffer from all sorts of corrosion, external and internal. When a substrate wall thickness goes under the minimum required thickness (Tmin), an action needs to take place either to cut and replace or repair the defected asset. In many cases a repair is deemed necessary as it is preferred to conduct asset replacement during the normal shut-down.

Internal corrosion affecting the pipeline's wall thickness inner side is particularly important for pipeline integrity compared to other form of corrosion. Internal metal loss is generally caused by the mixture of gases or liquids being transported, such as water, acid gases, and other factors including flow conditions, the metallurgy of the pipeline, microbiologically influenced corrosion, and operational factors, among others.

There are many repair solutions such as metallic sleeve, clamp and composite/non-metallic sleeve, etc. Composite sleeve/wrap is becoming a common repair method to restore pipe integrity due to installation ease, live-repair, minimum production interruption, no hot-work (safety), no purging/emission, light weight, no added stresses the structure, and durability (non-corrosive). Regardless of these benefits composite sleeve is used as a temporary solution especially for internal corrosion as it does not stop corrosion from progressing and once the sleeve is placed, area under repair is not inspectable by conventional technologies.

In principle, pipeline operators generally on rely non-destructive testing methods to monitor pipeline integrity, such as regular visual inspections, ultrasonic testing, and other methods. In-Line-Inspection (ILI) tool are also used. However, for most pipelines, the application of ILI tools is not practical. Additionally, ILI tools may not detect small defects due to limited resolution. Further, ILI tools may be difficult to utilize in pipelines that have tight bends.

Thus, the common methods for monitoring pipeline integrity methods are often time-consuming, expensive, and can be ineffective at detecting early-stage corrosion or metal loss. Further, inspections are only conducted periodically, leading pipeline operators without real time information on the pipeline's condition.

### SUMMARY

An embodiment described herein provides a method for monitoring internal corrosion in a compromised pipe. The method includes applying a reinforcement layer on an outer surface of a pipe over a defect detected in an internal surface of the pipe. A testing fiber Bragg grating (FBG) detector is mounted on the outer surface of the pipe over the defect. A reference FBG detector is mounted on the outer surface of the pipe. A difference in hoop strain between the testing FBG detector and the reference FBG detector is monitored to identify variations in wall thickness over the defect.

Another embodiment discloses a system for monitoring internal corrosion in a compromised pipe. The system includes a reinforcement layer on an outer surface of the pipe over a defect detected in an inner surface of the pipe. A testing fiber Bragg grating (FBG) detector is mounted on the outer surface of the pipe over the defect on the inner surface of the pipe. A reference FBG detector is mounted on the outer surface of the pipe. An interrogator is coupled to the testing FBG detector, wherein the interrogator measures a first wavelength shift of a reflected signal from the testing FBG detector. The interrogator is coupled to the reference FBG detector, wherein the interrogator measures a second wavelength shift of a reflected signal from the reference FBG detector. An analysis system is coupled to the interrogator, wherein the analysis system includes a processor and instructions. The instructions are operable to direct the processor to obtain the first wavelength shift from the interrogator, obtain the second wavelength shift from the interrogator, calculate hoop strain under the testing FBG detector, and calculate metal loss on the inside surface of the pipe under the reinforcement layer.

### BRIEF DESCRIPTION OF DRAWINGS

FIG. 1 is a schematic drawing of a fiber Bragg grating (FBG) system that is used to monitor metal loss under a reinforcing layer or composite sleeve.

FIG. 2 is a process flow diagram of a method 200 for monitoring metal loss in a defect on an inner surface of a pipe.

FIGS. 3A and 3B are drawings of the design of the simulated structures.

FIG. 4A is a plot of changes in the center wavelength of FBG at differing strains, which correspond to different metal loss thicknesses.

FIG. 4B is a plot of the correlation between the change in the center wavelength of the FBG and the strain, showing the metal loss thickness in millimeters.

FIGS. 5A and 5B are plots of the simulation results of differential hoop strain for GFRP structure against the internal uniform metal loss thickness (in millimeter scale) for two configurations (on pipe and on sleeve).

FIGS. 6A and 6B are plots of the simulation results of differential hoop strain for CFRP structure against the internal uniform metal loss thickness (in millimeter scale) for two configurations (on pipe and on sleeve).

FIGS. 7A and 7B are of the simulation results of differential hoop strain for GFRP structures against the internal localized metal loss thickness (in millimeter scale) at two different locations (on pipe and on sleeve).

FIGS. 8A and 8B are plots of the simulation results of differential hoop strain for CFRP structure against the internal localized metal loss thickness (in millimeter scale) at two different locations (on pipe and on sleeve).

FIGS. 9A and 9B are plots of a simulation of the hoop strain variation versus the metal loss thickness and for different values of the size of the defect (localized metal loss) at two different locations (on pipe and on sleeve).

FIGS. 10A and 10B are plots of a simulation of the hoop strain variation versus the metal loss thickness and for different values of the size of the defect (localized metal loss) at two different locations (on pipe and on sleeve).

### DETAILED DESCRIPTION

In recent years, advanced sensing technologies, such as Fiber Bragg Grating (FBG) sensors, have emerged as valuable tools for pipeline monitoring. FBG sensors reflect and filter specific wavelengths of light, making them ideal for measuring physical quantities such as temperature, strain, pressure, and more. FBG sensors are compact and have high sensitivity and reliability, providing economic feasibility in harsh environments.

Pipe segments used to form pipelines are generally selected from a standard grade pipe for oil and gas pipeline transmissions. For example, steel alloys used for pipe segments may include carbon steel, such as: API 5L, ASTM, API-5CT, including such grades as API 5L Glade B, API GradeX60, A106 Grade B, A333 Grade 6, and the like. The pipe thickness may range from 5.5-40 and the pipe diameter may range 2-50″ inches.

When a defect, or metal loss, in a pipe segment (or pipe) is detected, a temporary repair is made until the pipe segment be replaced. Two types of metal loss are observed in operation, uniform, and non-uniform (localized) metal loss. In uniform metal loss, a uniform reduction in the pipeline wall thickness occurs along many or all pipe segments. This is the case for general metal loss or erosion. Non-uniform metal loss, or localized metal loss, occurs when the reduction affects only a small region within the inner side of the pipeline, such as from corrosion pitting. The localized metal loss size may vary from 1 mm to 100 mm diameter size or more. Clusters of localized metal losses can occur in one area, such as low points in the pipeline, at points with side feeds from wells with higher water cuts, and the like.

Reinforcing layers, such as sleeves for wraps made from composite materials, have become a standard method for restoring the structural integrity of the pipe segment. The composite material is easy to apply, does not require welding and hot work, does not add substantial stress or load to structure and is durable, for example, lasting up to 20 years. The reinforcing layers or composite sleeve may be made of glass fiber-reinforced plastic (GFRP), carbon fiber-reinforced plastic (CFRP), aramid fiber reinforced plastic, and the like. The thickness of the reinforcing layer, or sleeve, is calculated based on the design pressure of the steel pipe, the pipe diameter, the allowable hoop strain, the hoop modulus of the sleeve, and the anticipated time frame for the end-of-life of the pipe wall. For example, the thickness of the composite sleeve may range between 1-50 mm or more depending on the prementioned criteria. The reinforcing layer includes fibers embedded in a matrix resin, which acts as a binder to consolidate the fibers to make solid structure. The matrix resin is usually a thermoset resin such as epoxy, vinyl ester, polyurethane, and the like. In some embodiments, the matrix material can be made of a thermoplastic resin as well. Generally, a filler material is applied underneath the reinforcing layer to transfer the load between the steel surface of the pipe and the reinforcing layer.

In most applications over corrosion on the internal surface of the pipeline, and in subsea environments, a reinforcing layer is considered a temporary solution, kept in place until the next scheduled shutdown, during which the defective section of the pipe is cut out and replaced. Reinforcing layers pose challenges for monitoring inner corrosion growth using conventional inspection methods, as the reinforcing layer itself provides a barrier to monitoring corrosion optically or through applied tools. The inability to monitor corrosion presents significant operational issues, as the timing of any failures in the repaired section cannot be anticipated.

Pipeline failures can have severe environmental and economic consequences, often leading to lengthy shutdowns that impact production. Accordingly, maintenance departments usually adopt a conservative approach to mitigate the risk of sudden failure by replacing repaired sections during regularly scheduled shutdowns, even if the composite wrap is still intact and the corrosion on the internal surface is under control. However, this approach is costly, as sectional pipeline replacement requires line shutdowns, isolation, and purging.

Therefore, techniques are needed to enable corrosion monitoring under reinforcing layers, avoiding unnecessary replacements, and extending the service life of pipeline assets. Embodiments described herein provide a method that uses FBG sensors to quantify metal loss on an internal surface of a repaired pipe section covered with a composite sleeve or reinforcing layer. Internal metal loss affects the stiffness of the pipe resulting in a change in the circumferential, or hoop strain, on the outer surface of the pipe. This variation in strain can then transfer to the reinforcing layer or composite sleeve wrapped around the pipe.

In some embodiments, an FBG sensor placed externally on the composite sleeve is configured to monitor these changes in hoop strain and use the collected data to monitor the metal loss status of the pipeline. Accordingly, using the methods described herein, pipeline operators can accurately and reliably monitor internal metal loss, allowing for proactive maintenance and preventing pipeline failures. These methods allow the detection of uniform metal loss, for example, from general corrosion and erosion, as well as localized metal loss or pitting.

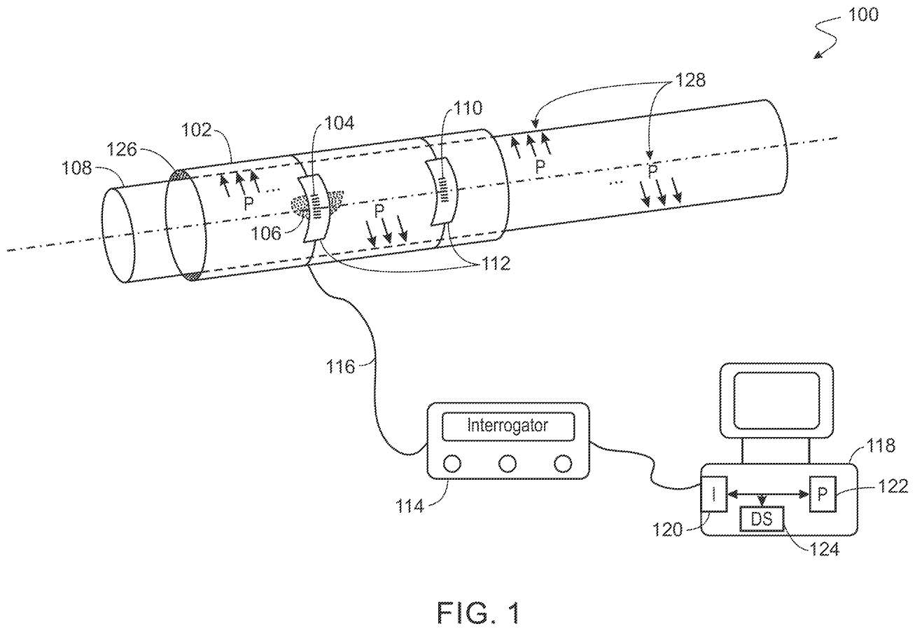

FIG. 1 is a schematic drawing of a fiber Bragg grating (FBG) system 100 that is used to monitor metal loss under a reinforcing layer or composite sleeve 102. A first FBG, termed a testing FBG sensor 104, is mounted on the composite sleeve over an internal defect 106, such as a localized metal loss in the wall of the pipe 108. A second FBG sensor, termed a reference FBG sensor 110, is mounted to the composite sleeve 102, away from the location of the internal defect 106, and is used as a reference to compensate for temperature effects. In some embodiments, each of the FBG sensors 104 and 110 are mounted to the composite sleeve 102 using an adhesive 112. In some embodiments, the FBG sensors 104 and 110 are mounted within the composite sleeve 102, for example, being placed on a layer of composite sleeve 102, then being covered with further layers of the composite sleeve 102 as it is wrapped around the pipe 108. In other embodiments, the FBG sensors 104 and 110 are mounted directly on the pipe 108, and the composite sleeve 102 is wrapped over the FBG sensors 104 and 110.

The two FBG sensors 104 and 110 are connected to an interrogation unit or interrogator 114, which is configured to send an optical signal through an optical fiber cable 116, or single mode fiber, to the FBG sensors 104 and 110 to measure the wavelength shift of the reflected signal. The wavelength shift is directly correlated to the strain experienced by the FBG sensors 104 and 110 and can be used to measure the extent of the internal defect 106 underneath the composite sleeve 102. The data on the wavelength shift that is collected by the FBG sensors 104 and 110 are analyzed using a computer 118. The use of the reference FBG sensor 110 for temperature compensation increases the precision of the measurements in varying temperature conditions.

The computer 118 includes a sensor interface 120 which couples the computer 118 to the interrogator 114, allowing the computer 118 to obtain wavelength shift data from each of the FBG sensors 104 and 110. The computer 118 includes a processor 122 and a data store 124, wherein the data store 124 includes instructions to direct the processor 122 to collect the wavelength shift data from each of the FBG sensors 104 and 110, and convert the wavelength shift into strain data, which allows for accurate measurement of the metal loss.

As described herein, in some embodiments, a filler 126 is applied over the pipe 108 prior to the composite sleeve 102. The filler 126 transfer stress from the pipe 108 to the composite sleeve 102. The adhesive 112 utilized for encapsulating the FBG sensors 104 and 110, and adhering the sensors to the composite sleeve 102, can be selected based on the location of the pipeline. For example, for subsea applications a hydrophilic adhesive is used.

The configuration shown in FIG. 1 is used in a pipe in which localized or pitting corrosion has been detected on the internal surface. In embodiments in which the pipe is subjected to general corrosion, or a corrosion lake is observed, several FBGs along with covering full circumference of the pipe can be utilized. A corrosion lake is a shape, or contour, of material loss in an area that is not as narrow as a pitting corrosion and not wide as general corrosion. A corrosion lake has a depth and area and may have pitting corrosion within the metal loss area. In these embodiments, an array of fiber gratings along the length of the composite sleeve 102 can be integrated.

As described herein, the metal loss can be calculated from the hoop strain of the pipe 108. In these calculations, it can be assumed that the pipe has radius R, wall thickness 8, and Young's modulus E and is subjected to an internal pressure P 128. The expression of the strain along the circumferential direction, known as hoop strain, can be expressed as ε=P·R/E·δ. In normal conditions, where pipeline pressure is typically steady, hoop strain ε is inversely proportional to pipe wall thickness. Therefore, any measured variations in hoop strain can be used to estimate a reduction in wall thickness caused by internal wall corrosion, with R and E assumed to remain constant even in the case of metal loss.

The hoop strain on the pipe 108 is transferred to the composite sleeve 102 mounted on the pipe 108. The testing FBG sensor 104 mounted on the composite sleeve 102 captures this strain. The FBG sensors 104 and 110 consist of a short length of optical fiber that includes an array of periodic defects, for example, created by laser etching, which create an interference pattern that reflects a specific wavelength of light. As the testing FBG sensor 104 is strained, the separation between the periodic defects changes, and the wavelength of light it reflects shifts proportionally to the strain values. The change in the wavelength of the light is detected and analyzed using the interrogation unit 114. As described herein, the interrogation unit 114 is connected to the FBG sensors 104 and 110 by an optical fiber cable 116, for example, including a single mode fiber for each of the FBG sensors 104 or 110. Thus, using the changes in the reflected wavelengths of light, the testing FBG sensor 104 can accurately measure the strain experienced by the composite sleeve and, which correlates to the amount of metal loss affecting the pipeline wall. Furthermore, since the FBG sensor is sensitive to both the strain and the temperature variations, the reference FBG sensor 110, placed on the composite sleeve 102 near the testing FBG sensor 104, is used to compensate for temperature. The reference FBG sensor 110 does not directly measure temperature but it measures change in hoop strain as the pipe expands and contracts during temperature variations.

Thus, the strain measurement from the testing FBG sensor 104 is related to the corrosion status of the pipeline. If there are a number of corrosion defects on the same pipeline, a number of FBG sensors can be deployed in a distributed manner along the pipe or along the repaired section to collectively provide information about the corrosion status of each section. One interrogation unit can be used to receive signal, locate positions, and follow wavelength shifts of all the FBG sensors.

The method and system is non-invasive and, thus, eliminates the need for invasive procedures that damage the pipeline's structure. It provides accurate and reliable internal metal loss measurements, making it an effective tool for long-term monitoring. The FBG sensors 104 and 110 are durable and can withstand harsh environmental conditions, making it suitable for use in challenging environments. It is a cost-effective approach to monitoring metal loss compared to traditional inspection methods, making it an attractive option for pipeline operators looking to improve their maintenance and inspection capabilities.

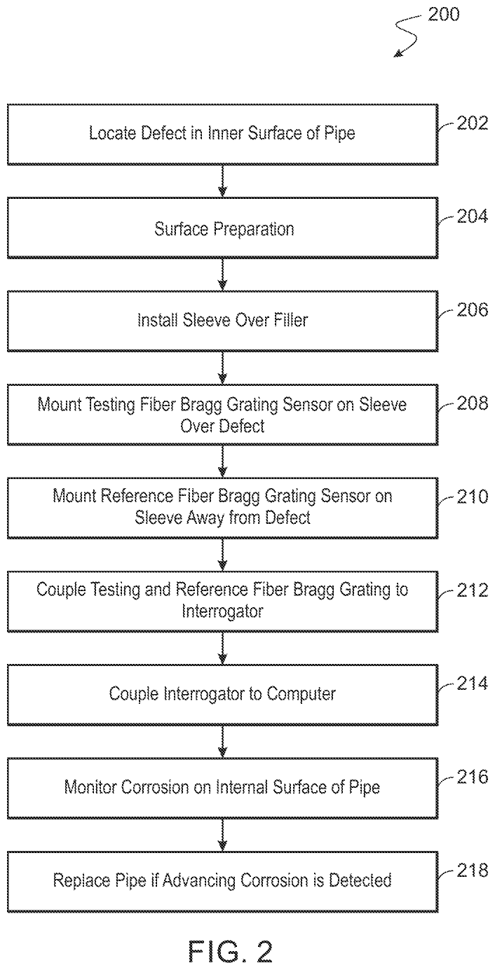

FIG. 2 is a process flow diagram of a method 200 for monitoring metal loss in a defect on an inner surface of a pipe. The method 200 begins at block 202 when a defect is located on an inner surface of a pipe. This may be performed by ultrasonic testing, imaging, or other testing techniques. In some embodiments, at block 204 the surface is prepared for the repair, for example, a filler is applied to the outer surface of the pipe over the defect. At block 206, a sleeve is installed over the filler. As described herein, the sleeve may be a reinforced layer of plastic, such as a glass fiber reinforced plastic or a carbon fiber reinforced plastic, among others. At block 208, a testing FBG sensor is mounted on the sleeve over the defect on the inner surface of the pipe. At block 210, a reference FBG sensor is mounted on the sleeve away from the defect. At block 212, the testing FBG sensor and the reference FBG sensor are coupled to an interrogator by a fiber-optic cable, such as a single mode fiber. In some embodiments, a single mode fiber is coupled to each FBG sensor. In other embodiments, a single fiber is used to couple to each of the FBG sensors in series, wherein each sensor response at a different wavelength. At block 214, the interrogator is coupled to a computer, for example, by a serial interface, a parallel interface, a Wi-Fi interface, a network interface, and the like. At block 216, the corrosion on the internal surface of the pipe is monitored. At block 218, the piping is replaced if advancing corrosion is detected.

### EXAMPLES

The utility and the efficiency of the FBG sensors in monitoring the internal metal loss with glass fiber reinforced plastic (GFRP) and carbon reinforced plastic (CFRP) sleeves on carbon steel pipe were tested by simulation. The hoop strain variations were tested in two configurations. In a first configuration, the FBG sensors were placed on the top of composite sleeve. In another configuration, the FBG sensors were embedded at the interface between the steel surface and composite sleeve. Two design structures were simulated for every defect type, uniform and localized. As shown in the examples below, the sensitivity of the technique increases with the size of the defect. For example, as the thickness variation or metal loss increases, the response also increases.

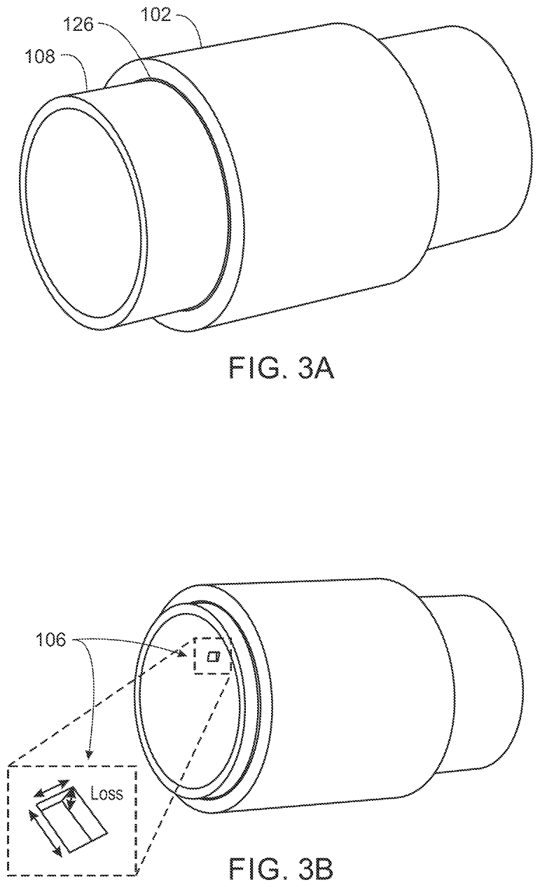

FIGS. 3A and 3B are drawings of the design of the simulated structures. The uniform metal loss was simulated using different pipeline wall thicknesses while an internal defect 106 of 10×10 mm in size, as shown in the inset view of FIG. 3B, was simulated for localized metal loss. The material and design features of different layers are summarized in Table 1 and 2, respectively, which were used as inputs for the simulation work for the proposed examples.

TABLE 1
material properties of different layers for the simulation examples

| Layers | Pipe | Filler | GFRP | CFRP |
|---|---|---|---|---|
| Young's Modulus [GPa] | 200 | 4 | 30 | 100 |
| Poisson's Ratio | 0.33 | 0.3 | 0.41 | 0.15 |
| Density (kg/m\hat{ }3) | 7850 | 1200 | 2000 | 1500 |

TABLE 2
exemplary pipe designs for simulation work

| | GFRP | CFRP |
|---|---|---|
| Pipe inner Diameter [cm] | 9.2 | 9.2 |
| Pipe outer Diameter [cm] | 11.8 | 11.8 |
| Pipe Thickness [mm] | 13 | 13 |
| GFRP Sleeve Thickness [mm] | 7 | 6 |

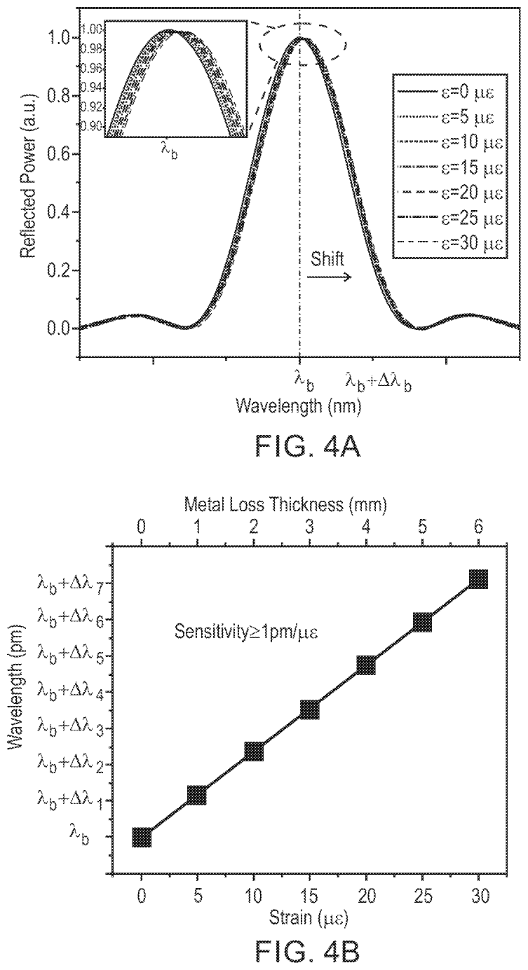

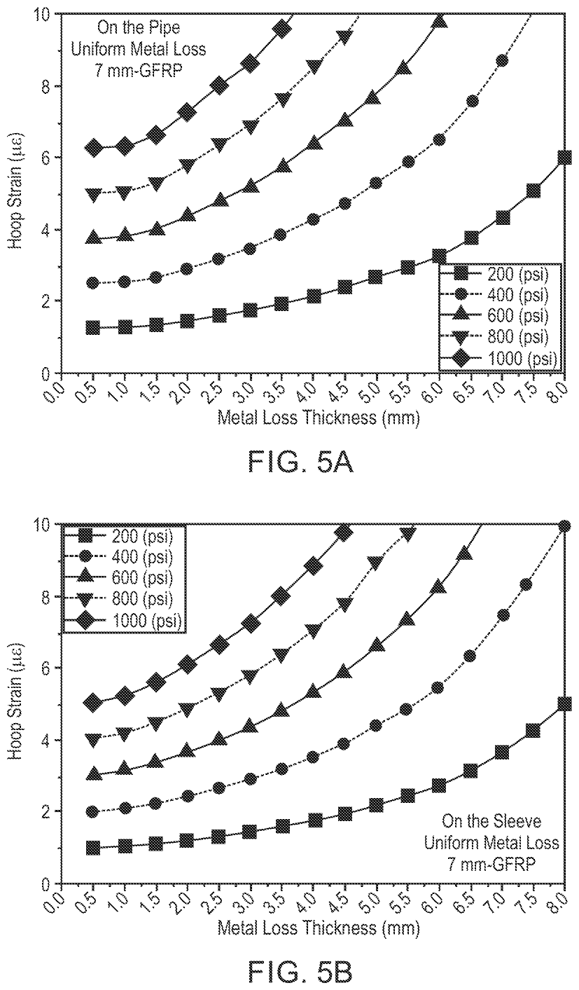

FIG. 4A is a plot of changes in the center wavelength of FBG at differing strains, which correspond to different metal loss thicknesses. FIG. 4B is a plot of the correlation between the change in the center wavelength of the FBG and the strain, showing the metal loss thickness in millimeters.

An FBG sensor is a passive optical component queried by periodically recording the wavelength modulation along the length of the optical fiber core. The measured data is encoded in the wavelength of the light reflected by the FBG. The FBG reflects a narrowband of light at a specific wavelength, often known as Bragg wavelength: λ_{b}. Any change in the temperature or the strain contributes to the shift of the reflected wavelength by Δλ. Incorporating a reference FBG for temperature effect compensation, the strain variation caused by metal loss could be discriminated. The shift of the center reflected wavelength of the FBG due to the strain change is shown in FIG. 4A.

FIG. 4B is a schematic of the variation of the Bragg wavelength versus the strain and the equivalent metal loss thickness. The minimum detectable metal loss thickness is constrained by the sensitivity of the FBG sensor, the placement of the sensor on the sleeve, the background noise (for example, temperature), the interrogator resolution, and the pipe diameter, internal pressure, thickness and size. The minimum detectable metal loss is also affected by whether the pipe is located on land, underground, or underwater. The benefits of FBG sensors make them applicable and effective for monitoring the integrity and performance of onshore and offshore pipelines. Thus, the method described herein can monitor internal metal loss under composite sleeves using FBG sensors that are either placed on the sleeve or at the interface between the composite sleeve and the pipe depending on the desired sensitivity and applicability.

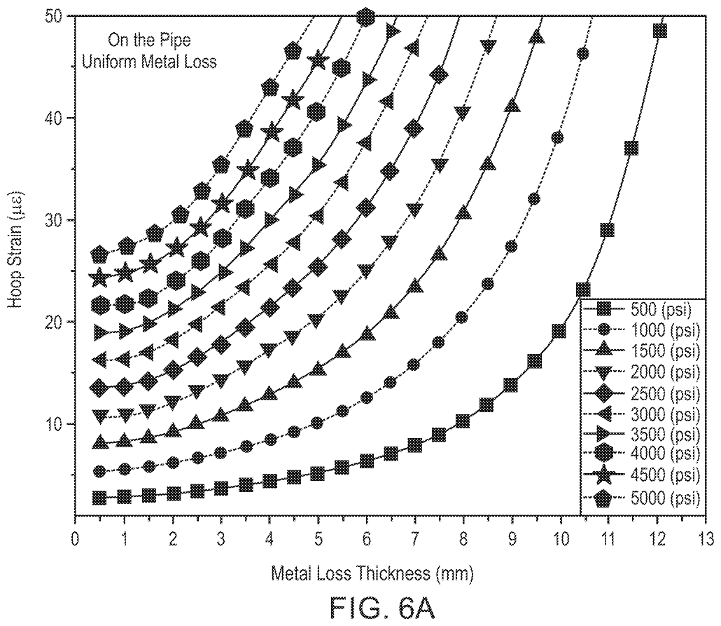

FIGS. 5A and 5B are plots of the simulation results of differential hoop strain for GFRP structure against the internal uniform metal loss thickness (in millimeter scale) for two configurations (on pipe and on sleeve). The plots in FIGS. 5A and 5B are for various internal pressures between 200-1000 psi. The strain increases as the thickness of metal loss increases, which is equivalent to a reduction in pipe wall thickness. Since commercial interrogators have a resolution of around 1 pm which corresponds to a strain resolution of 1με, FBG sensor is capable to detect slight variations in the hoop strain. The sensitivity of FBG sensors allows them to detect small changes in hoop strain with a precision of Δε=1με. Such variations can indicate a slight amount of uniform metal loss less than 0.5 mm for both configurations.

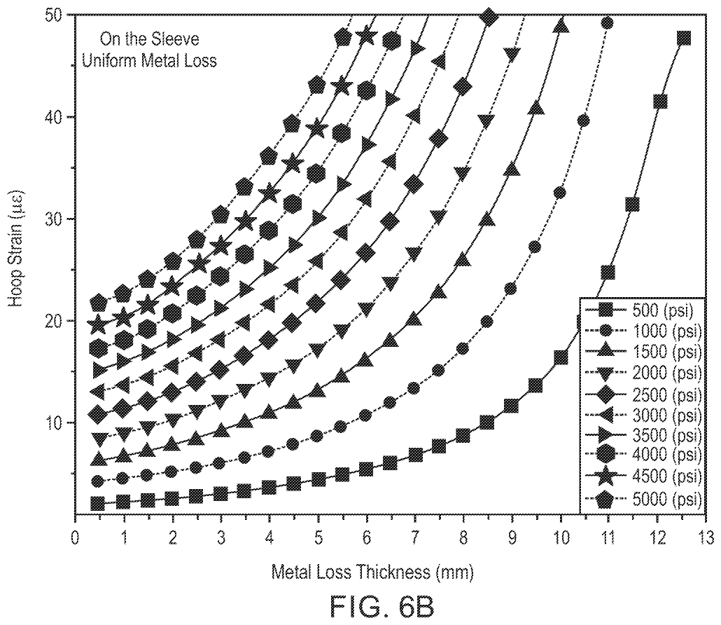

FIGS. 6A and 6B are plots of the simulation results of differential hoop strain for CFRP structure against the internal uniform metal loss thickness (in millimeter scale) for two configurations (on pipe and on sleeve). The plots in FIGS. 6A and 6B are for various internal pressures between 500-5000 psi. The strain increases as the thickness of metal loss increases, which is equivalent to a reduction in pipe wall thickness. Since commercial interrogators have a resolution of around 1 pm which corresponds to a strain resolution of 1με, the FBG sensors is capable to detect slight variations in the hoop strain. The sensitivity of FBG sensors allows them to detect small changes in hoop strain with a precision of Δε=1με. Such variations can indicate a slight amount of uniform metal loss less than 0.5 mm for both configurations.

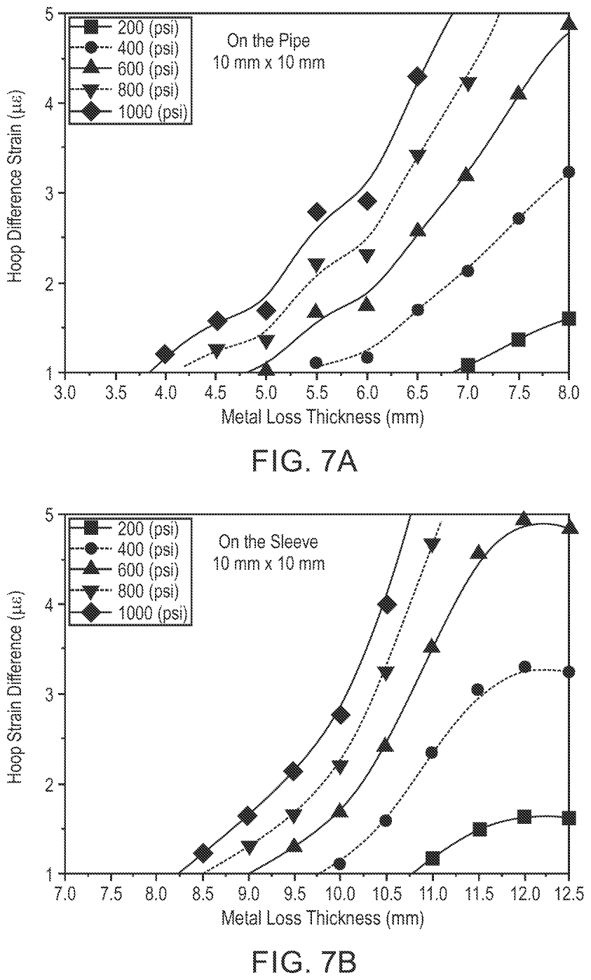

FIGS. 7A and 7B are of the simulation results of differential hoop strain for GFRP structures against the internal localized metal loss thickness (in millimeter scale) at two different locations (on pipe and on sleeve). The plots in FIGS. 7A and 7B are for various internal pressures between 200 psi, 400 psi, 600 pis, 800 psi, and 1000 psi. The size of the metal loss is simulated to be 10 mm×10 mm (width×length) in this case. Again, strain increases as the thickness of metal loss increases, which is equivalent to a reduction in pipe wall thickness. The minimum detectable metal loss is highly dependent on internal pressure applied. For FBG strain resolution of 1με, the minimum detectable metal loss thickness is ranges from around 3.5 mm to 7 mm for “on pipe” configuration and from around 8 mm to 11 mm for “on sleeve” configuration.

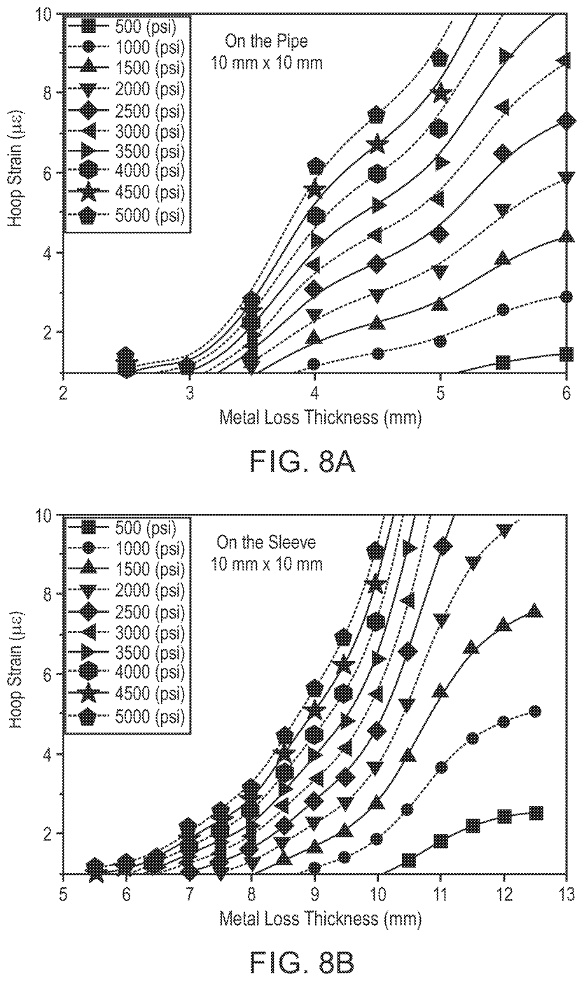

FIGS. 8A and 8B are plots of the simulation results of differential hoop strain for CFRP structure against the internal localized metal loss thickness (in millimeter scale) at two different locations (on pipe and on sleeve). For various internal pressures between 500-5000 psi. it is worth noting at the size of the metal loss is a simulated to be 10 mm×10 mm (width×length) in this case. Again, strain increases as the thickness of metal loss increases, which is equivalent to a reduction in pipe wall thickness. Here is the minimum detectable metal loss is highly dependent on internal pressure applied. For FBG strain resolution of 1με, the minimum detectable metal loss thickness is ranges from around 2.5 mm to 5 mm for “on pipe” configuration and from around 5.5 mm to 10 mm for “on sleeve” configuration.

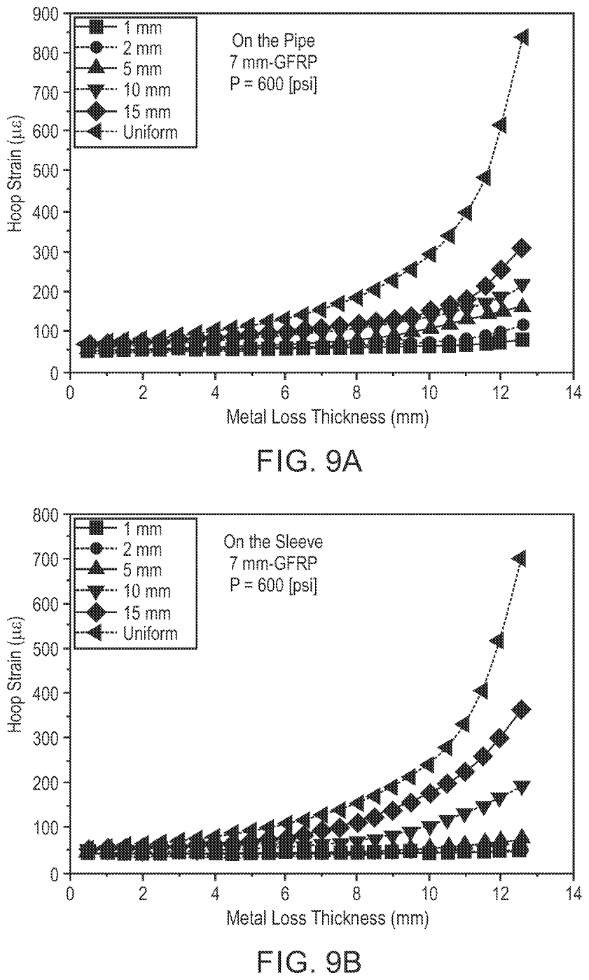

FIGS. 9A and 9B are plots of a simulation of the hoop strain variation versus the metal loss thickness and for different values of the size of the defect (localized metal loss) at two different locations (on pipe and on sleeve). The defect here is simulated as a square hole of side length l, wherein l ranges from 1 to 15 mm. The depth of the simulated whole is shown as “the metal loss thickness”. In the simulation of FIGS. 9A and 9B, the sleeve is simulated as a 7 mm GFRP. In this simulation, the pipe thickness is 13 mm and the applied internal pressure is 600 psi.

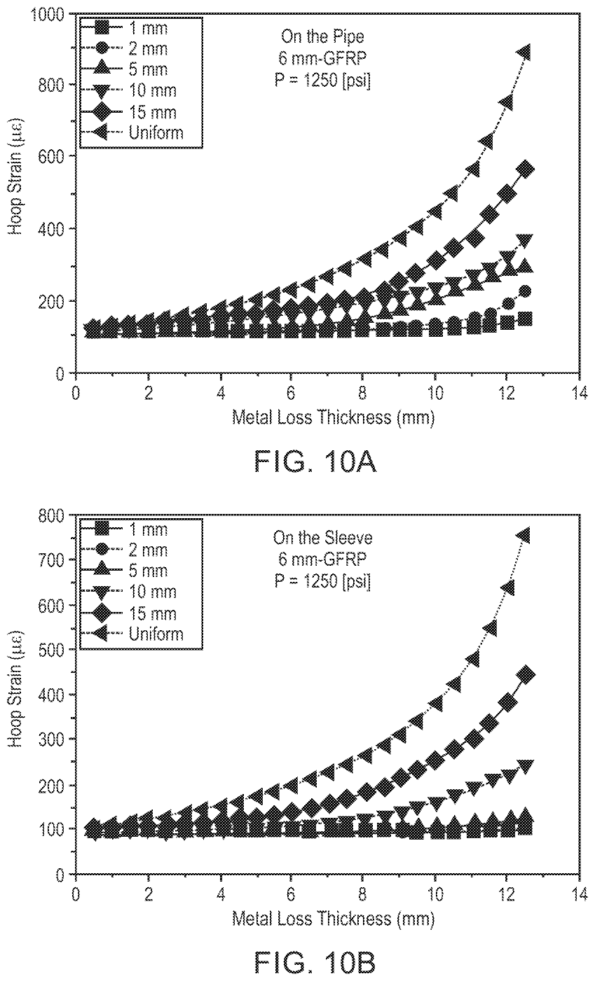

FIGS. 10A and 10B are plots of a simulation of the hoop strain variation versus the metal loss thickness and for different values of the size of the defect (localized metal loss) at two different locations (on pipe and on sleeve). The defect here is simulated as a hole of radius r, wherein r ranges from 1 to 15 mm. The uniform metal loss case is also shown. The depth of the simulated whole is shown as “the metal loss thickness”. In the simulation of FIGS. 10A and 10B, the sleeve is simulated as a 6 mm CFRP. In this simulation, the pipe thickness is 13 mm and the applied internal pressure is 1200 psi.

Two configurations are simulated: one with 7 mm GFRP and the second is with 6 mm CFRP. The pipe thickness is 13 mm, and the applied internal pressures are 600 psi for the first structure, while 1250 psi is applied in the second. The results are highlighted for both case: the FBG is mounted on the pipe and the FBG is placed externally on the sleeve.

The results for the simulations of FIGS. 9A, 9B, 10A, and 10B are summarized in Table 3. The minimum detectable metal loss increases as the size of the defect increases. This is attributed to the fact that the internal pressure applied on the defect location (i.e., area) is applied also on the wall of the defect. This will increase the area and the value of the captured strain either on the outer side of the pipe or on the sleeve. Taking into consideration the FBG strain resolution of lux, Table 3 shows the minimum detectable metal loss, calculated for each case and each scenario (i.e., defect size and the placement of the FBG.

TABLE 3
Minimum detectable metal loss for both simulated configurations
and for different values of the defect size.

| | Metal loss thickness | |
|---|---|---|
| Defect surface | GFRP | CFRP |

| | | | | |
|---|---|---|---|---|
| area I | On pipe | On sleeve | On pipe | On sleeve |

| | | | | | |
|---|---|---|---|---|---|
| 1 | mm | 10 mm | — | 10 mm | — |
| 2 | mm | 8 mm | — | 7 mm | — |
| 5 | mm | 5 mm | 10 mm | 4 mm | 9 mm |
| 10 | mm | 2 mm | 4 mm | 1 mm | 4 mm |
| 15 | mm | 1 mm | | | 1 mm |

### EMBODIMENTS

An embodiment described herein provides a method for monitoring internal corrosion in a compromised pipe. The method includes applying a reinforcement layer on an outer surface of a pipe over a defect detected in an internal surface of the pipe. A testing fiber Bragg grating (FBG) detector is mounted on the outer surface of the pipe over the defect. A reference FBG detector is mounted on the outer surface of the pipe. A difference in hoop strain between the testing FBG detector and the reference FBG detector is monitored to identify variations in wall thickness over the defect.

In an aspect, combinable with any other aspect, mounting the reinforcement layer includes applying a filler on the outer surface of the pipe over the defect, and then mounting the reinforcement layer over the filler.

In an aspect, combinable with any other aspect, mounting the reinforcement layer includes wrapping the pipe with the reinforcement layer.

In an aspect, combinable with any other aspect, mounting the reinforcement layer includes mounting a sleeve of the reinforcement layer over the pipe.

In an aspect, combinable with any other aspect, the reinforcement layer includes a glass fiber-reinforced plastic (GFRP) composite.

In an aspect, combinable with any other aspect, the reinforcement layer includes a carbon fiber-reinforced plastic (CFRP) composite.

In an aspect, combinable with any other aspect, mounting the testing FBG detector over the defect includes mounting the testing FBG detector on the outer surface of the pipe over the defect then applying the reinforcement layer.

In an aspect, combinable with any other aspect, mounting the testing FBG detector over the defect includes incorporating the testing FBG detector into the reinforcement layer.

In an aspect, combinable with any other aspect, mounting the testing FBG detector over the defect includes adhering the testing FBG detector onto the surface of the reinforcement layer.

In an aspect, combinable with any other aspect, including using the variations in wall thickness over the defect to determine a localized metal loss In an aspect, the defect is between about 1 mm and about 100 mm in size. In an aspect, the the localized metal loss is between about 0.5 mm and about 10 mm. In an aspect, the the localized metal loss is between about 3.5 mm and about 7 mm. In an aspect, the the localized metal loss is between about 8 mm and about 11 mm. In an aspect, the detectable amount of localized metal loss is inversely proportional to a size of the defect.

Another embodiment discloses a system for monitoring internal corrosion in a compromised pipe. The system includes a reinforcement layer on an outer surface of the pipe over a defect detected in an inner surface of the pipe. A testing fiber Bragg grating (FBG) detector is mounted on the outer surface of the pipe over the defect on the inner surface of the pipe. A reference FBG detector is mounted on the outer surface of the pipe. An interrogator is coupled to the testing FBG detector, wherein the interrogator measures a first wavelength shift of a reflected signal from the testing FBG detector. The interrogator is coupled to the reference FBG detector, wherein the interrogator measures a second wavelength shift of a reflected signal from the reference FBG detector. An analysis system is coupled to the interrogator, wherein the analysis system includes a processor and instructions. The instructions are operable to direct the processor to obtain the first wavelength shift from the interrogator, obtain the second wavelength shift from the interrogator, calculate hoop strain under the testing FBG detector, and calculate metal loss on the inside surface of the pipe under the reinforcement layer.

In an aspect, combinable with any other aspect, the testing FBG detector is mounted to the surface of the reinforcement layer.

In an aspect, combinable with any other aspect, the reference FBG detector is mounted to the surface of the reinforcement layer.

In an aspect, combinable with any other aspect, the reinforcement layer includes a glass fiber-reinforced plastic composite.

In an aspect, combinable with any other aspect, the reinforcement layer includes a carbon fiber-reinforced plastic composite.

In an aspect, combinable with any other aspect, the reinforcement layer includes an epoxy, a polyurethane, or a vinyl ester, or any combinations thereof.

Other implementations are also within the scope of the following claims.

What is claimed is:

1. A method for monitoring internal corrosion in a compromised pipe, comprising:
applying a reinforcement layer on an outer surface of a pipe over a defect detected in an internal surface of the pipe;
mounting a testing fiber Bragg grating (FBG) detector on the outer surface of the pipe over the defect;
mounting a reference FBG detector on the outer surface of the pipe; and
monitoring a difference in hoop strain between the testing FBG detector and the reference FBG detector to identify variations in wall thickness over the defect.

2. The method of claim 1, wherein mounting the reinforcement layer comprises applying a filler on the outer surface of the pipe over the defect, and then mounting the reinforcement layer over the filler.

3. The method of claim 1, wherein mounting the reinforcement layer comprises wrapping the pipe with the reinforcement layer.

4. The method of claim 1, wherein mounting the reinforcement layer comprises mounting a sleeve of the reinforcement layer over the pipe.

5. The method of claim 1, wherein the reinforcement layer comprises a glass fiber-reinforced plastic (GFRP) composite.

6. The method of claim 1, wherein the reinforcement layer comprises a carbon fiber-reinforced plastic (CFRP) composite.

7. The method of claim 1, wherein mounting the testing FBG detector over the defect comprises mounting the testing FBG detector on the outer surface of the pipe over the defect then applying the reinforcement layer.

8. The method of claim 1, wherein mounting the testing FBG detector over the defect comprises incorporating the testing FBG detector into the reinforcement layer.

9. The method of claim 1, wherein mounting the testing FBG detector over the defect comprises adhering the testing FBG detector onto the surface of the reinforcement layer.

10. The method of claim 1, comprising using the variations in wall thickness over the defect to determine a localized metal loss.

11. The method of claim 10, wherein the defect is between about 1 mm and about 100 mm in size.

12. The method of claim 10, wherein the localized metal loss is between about 0.5 mm and about 10 mm.

13. The method of claim 10, wherein the localized metal loss is between about 3.5 mm and about 7 mm.

14. The method of claim 10, wherein the localized metal loss is between about 8 mm and about 11 mm.

15. The method of claim 10, wherein the detectable amount of localized metal loss is inversely proportional to a size of the defect.

16. A system for monitoring internal corrosion in a compromised pipe, comprising:
a reinforcement layer on an outer surface of the pipe over a defect detected in an inner surface of the pipe;
a testing fiber Bragg grating (FBG) detector mounted on the outer surface of the pipe over the defect on the inner surface of the pipe;
a reference FBG detector mounted on the outer surface of the pipe;
an interrogator coupled to the testing FBG detector, wherein the interrogator measures a first wavelength shift of a reflected signal from the testing FBG detector;
the interrogator coupled to the reference FBG detector, wherein the interrogator measures a second wavelength shift of a reflected signal from the reference FBG detector; and
an analysis system coupled to the interrogator, wherein the analysis system comprises:
a processor; and
instructions operable to direct the processor to:
obtain the first wavelength shift from the interrogator;
obtain the second wavelength shift from the interrogator;
calculate hoop strain under the testing FBG detector; and
calculate metal loss on the inside surface of the pipe under the reinforcement layer.

17. The system of claim 16, wherein the testing FBG detector is mounted to the surface of the reinforcement layer.

18. The system of claim 16, wherein the reference FBG detector is mounted to the surface of the reinforcement layer.

19. The system of claim 16, wherein the reinforcement layer comprises a glass fiber-reinforced plastic composite.

20. The system of claim 16, wherein the reinforcement layer comprises a carbon fiber-reinforced plastic composite.

21. The system of claim 16, wherein the reinforcement layer comprises an epoxy, a polyurethane, or a vinyl ester, or any combinations thereof.
